(19) United States
(12) Patent Application Publication
(10) Pub. No.: US 2015/0244133 A1
(43) Pub. Date: Aug. 27, 2015

(54) TERMINAL-EQUIPPED WIRING MEMBER

(71) Applicant: Yazaki Corporation, Tokyo (JP)

(72) Inventor: Hisashi HANAZAKI, Susono-shi (JP)

(73) Assignee: YAZAKI CORPORATION, Tokyo (JP)

(21) Appl. No.: 14/631,351

(22) Filed: Feb. 25, 2015

(30) Foreign Application Priority Data
Feb. 27, 2014 (JP) 2014-037146

(51) Int. Cl. H01R 43/24

(52) U.S. Cl. CPC H01R 43/24

(57) ABSTRACT

A terminal-equipped wiring member includes a wiring member having a conductor covered with an insulating cover, a terminal having an electric contact portion configured to be electrically connected to a mating terminal and a conductor connection portion connected to the conductor, and a metallic connection portion formed at the conductor connection portion by stereoscopic shaping and configured to embed the conductor therein so that the conductor connection portion and the conductor are integrally fixed to each other.

### BACKGROUND

The present invention relates to a wiring member equipped with a terminal.

In wire harnesses for use in vehicles, electric circuits are composed of wiring members so that electric components are electrically connected and perform functions. The conductors of the wiring members are covered with insulating covers. Various types are available as the wiring members, such as a covered wire, a flat cable (FC), a flexible flat cable (FFC) and a flexible printed circuit (FPC) (for example, refer to JP-A-2014-17361).

Connectors are generally used to connect these wiring members to electric components. The terminals connected to the conductors of the wiring members are accommodated in the insulating housings of the connectors. Various types are also available as terminal connection structures constituting terminal-equipped wiring members to which the conductors of the wiring members are connected. The terminal connection structures include, for example, crimping, pressure contact, ultrasonic joining, piercing and soldering. These terminal connection structures are selected appropriately depending on the types of the above-mentioned wiring members.

Crimping is a terminal connection structure in which a conductor is held between a pair of crimping pieces formed at the conductor connection portion of a terminal and crimped. With this crimping, parts of the crimping pieces and the conductor are agglutinated (bonded in a molecular or atomic level). Pressure contact is a terminal connection structure in which an electric wire is pressed against a cut slot formed in the pressure contact blade of a terminal, the insulating cover of the electric wire is torn at the inner edges of the cut slot, and the conductor being exposed is made contact with the cut slot. Ultrasonic joining is a terminal connection structure in which a terminal and a conductor are held between an ultrasonic chip and an anvil, an ultrasonic wave is applied to the conductor and the terminal from the ultrasonic chip, and the heat generated is used to weld the terminal to the conductor. Piercing is a terminal connection structure in which a crimping blade passes through the conductor and the insulating cover of an FFC, is bent and crimped to the FFC, and is electrically connected to the conductor of the FFC (for example, refer to JP-A-2006-331930). Soldering is a terminal connection structure in which, while a terminal is made contact with a conductor, solder is heated and melted and then hardened, whereby the terminal is joined (brazed) with the conductor.

However, the above-mentioned conventional terminal-equipped wiring members are respectively required to have exclusive terminals being different depending on the type of the terminal connection structure. For example, crimping pieces, pressure contact blades, crimping blades for piercing, and flat faces to be joined for ultrasonic joining and soldering are required as conductor connection portions. Hence, the kinds of terminals increase, and component management becomes complicated. In addition, processing facilities being different depending on the terminal connection structure are required, and facility cost increases. The complicated component management and the increase in facility cost have been factors that cause increase in the cost of products.

In consideration of the above-mentioned circumstances, an object of the present invention is to provide a terminal-equipped wiring member capable of reducing manufacturing cost by decreasing the kinds of exclusive terminals and by decreasing different kinds of processing facilities.

### SUMMARY

The above-mentioned object according to the present invention will be achieved by using the configuration described below.

(1) There is provided a terminal-equipped wiring member including:

a wiring member having a conductor covered with an insulating cover;

a terminal having an electric contact portion configured to be electrically connected to a mating terminal and a conductor connection portion connected to the conductor; and

a metallic connection portion which is formed at the conductor connection portion by stereoscopic shaping and is configured to embed the conductor therein so that the conductor connection portion and the conductor are integrally fixed to each other.

With the terminal-equipped wiring member having the configuration described in the above item (1), the metallic connection portion is formed by stereoscopic shaping at the conductor connection portion of the terminal. While the conductor is placed on the conductor connection portion, a forming material is gradually laminated (stacked) on the conductor connection portion by stereoscopic shaping (three-dimension molding), and thus the metallic connection portion is formed. Hence, the conductor placed on the conductor connection portion is buried (embedded) into the metallic connection portion having been formed by stereoscopic shaping.

Hence, the contact area between the terminal and the conductor in the metallic connection portion can be made larger than that in the conventional terminal connection structure (mechanical fastening), such as crimping, pressure contact and piercing. In addition, the damage to the conductor due to plastic deformation is smaller than the damage due to mechanical fastening. As a result, the tensile strength between the terminal and the electric wire can be raised to as high as the tensile strength of the conductor.

Additionally, the kinds of components can be decreased and the kinds of processing facilities can also be decreased by sharing the terminal and the stereoscopic shaping machine. As a result, component/facility management cost and processing cost can be reduced, and manufacturing cost can be reduced.

(2) The terminal-equipped wiring member having the configuration described in the above item (1), wherein the conductor connection portion is formed as a bottom plate having a rectangular plate shape and extending from the electric contact portion.

In the terminal-equipped wiring member having the configuration described in the above item (2), the conductor connection portion is formed into a common shape, that is, a simple rectangular plate shape. With this configuration, the manufacturing cost of the terminal can be reduced. Since the conductor connection portion has a flat face, the laser irradiation can be facilitated, for example, in the case that the powder sintering lamination shaping method is used for stereoscopic shaping.

(3) The terminal-equipped wiring member having the configuration described in the above item (2), wherein the metallic connection portion continuously covers both the conductor and the cover.

The metallic connection portion of the terminal-equipped wiring member having the configuration described in the above item (3) completely covers the conductor exposed at the terminal end of the electric wire, and thus water stopping among the wire strands of the conductor can be achieved.

The terminal-equipped wiring member according to the present invention makes it possible to decrease the kinds of exclusive terminals and decrease the kinds of different processing facilities, thereby reducing the manufacturing cost.

The present invention has been described above briefly. The details of the present invention will be further clarified by reading the description of the modes (hereafter referred to as “embodiments”) for carrying out the invention described below referring to the accompanying drawings.

### BRIEF DESCRIPTION OF THE DRAWINGS

FIG. 1 is a side view illustrating a terminal-equipped wiring member according to a first embodiment of the present invention.

FIG. 2 is a cross-sectional view taken on line A-A of FIG. 1.

FIGS. 3A to 3C are process explaining views illustrating the process for forming a metallic connection portion at the conductor connection portion of a terminal using stereoscopic shaping; FIG. 3A illustrates a state before the metallic connection portion is formed at the conductor connection portion, FIG. 3B illustrates a process in which the metallic connection portion is formed at the conductor connection portion of the terminal by stereoscopic shaping, and FIG. 3C illustrates a state after the connection of the conductor is completed using the metallic connection portion formed at the conductor connection portion of the terminal by stereoscopic shaping.

FIG. 4 is a side view illustrating a terminal-equipped wiring member according to a second embodiment of the present invention.

FIG. 5 is a side view illustrating a terminal-equipped wiring member according to a third embodiment of the present invention.

### DETAILED DESCRIPTION OF EXEMPLARY EMBODIMENTS

Exemplary embodiments according to the present invention will be described below with reference to the drawings.

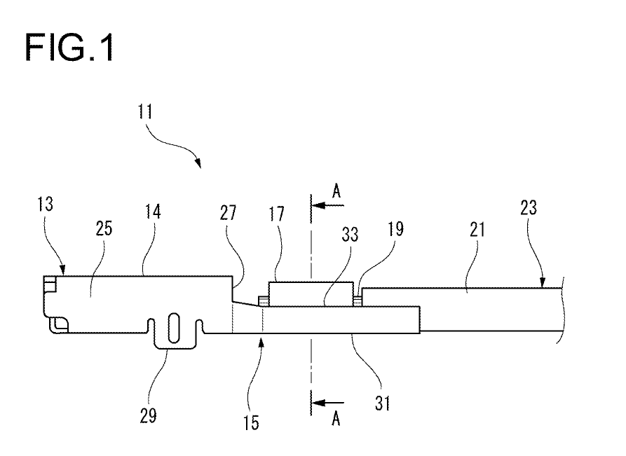

As illustrated in FIG. 1, a terminal-equipped wiring member 11 according to a first embodiment of the present invention includes an electric wire 23 serving as a wiring member, a terminal 13 electrically connected to the terminal end of the electric wire 23, and a metallic connection portion 17 that is configured to integrally fix the conductor connection portion 15 of the terminal 13 to the conductor 19 of the electric wire 23.

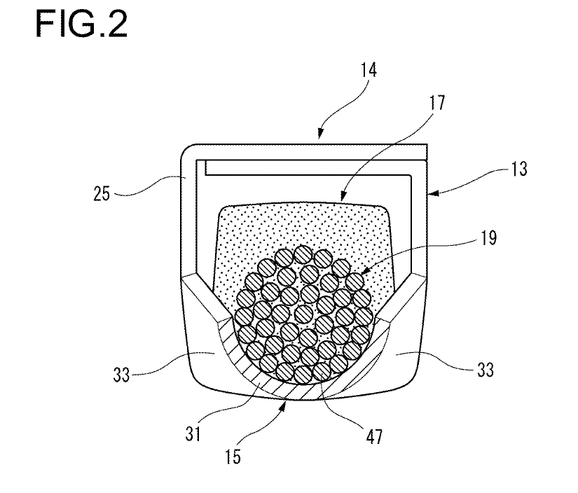

As a wiring member according to this embodiment, the electric wire 23 having the conductor 19 covered with an insulating cover (insulating sheath) 21 is used. FC, FFC, FPC, etc. can also be used as wiring members as a matter of course. In the electric wire 23 according to this embodiment, the conductor 19 is formed by twisting a plurality of strands 47 (see FIG. 2). The conductor 19 may include a single wire. The conductor 19 is made of copper, aluminum, etc. The circumference of the conductor 19 is covered with the insulating cover 21. The insulating cover 21 is made of an insulating synthetic resin. A resin containing a flame retardant added to a base material, such as polyvinyl chloride (PVC), polyolefin or polyamide, can be used as the synthetic resin. A halogen-based flame retardant, a phosphorus-based flame retardant, magnesium hydroxide, aluminum hydroxide, etc. are generally used as the flame retardant.

The terminal 13 according to the first embodiment can be formed by punching and bending a single conductive metal plate. The terminal 13 is mounted and used, for example, in a connector housing (not shown). An electric contact portion 14 and the conductor connection portion 15 are continuously provided from the tip end side of the terminal 13.

The electric contact portion 14 is electrically made contact with a mating terminal. The conductor connection portion 15 is electrically connected to the conductor 19. A box section 25 having a rectangular cylindrical shape is formed at the electric contact portion 14. The box section 25 receives the tab-shaped conductor connection portion of a male terminal (not shown) serving as the mating terminal and is conductively connected to the male terminal. In other words, the terminal 13 is a female terminal.

A lance locking section 27 is formed in the box section 25. When the terminal 13 enters the terminal housing chamber of the connector housing, the lance locking section 27 is locked to the lance formed on the connector housing from behind. Hence, the terminal 13 is restricted from coming off backward from the terminal housing chamber. Furthermore, the box section 25 is provided with a spacer contact section 29. When a spacer (not shown) is mounted on the connector housing, the secondary locking section formed on the spacer is made contact with the spacer contact section 29.

A pair of parallel rising pieces 33 (see FIGS. 1 and 2) standing upright from both the side edge sections of a bottom plate 31 having a rectangular plate shape and extending from the box section 25 of the electric contact portion 14 is formed in the conductor connection portion 15 according to the first embodiment. Since the rising pieces 33 are provided in the conductor connection portion 15, a forming material (melted metal) can be suppressed from flowing out and formability can be improved during stereoscopic shaping. In addition, since the pair of rising pieces 33 is formed on both the side edge sections of the bottom plate 31, the connection strength between the conductor connection portion 15 and the metallic connection portion 17 can be raised.

The metallic connection portion 17 according to the first embodiment is formed on the conductor connection portion 15 by stereoscopic shaping. In the metallic connection portion 17, the conductor 19 is embedded so that the conductor connection portion 15 and the conductor 19 are fixed integrally as illustrated in FIG. 2. In the first embodiment, the metallic connection portion 17 is formed into a nearly cubic shape by stereoscopic shaping so that the extension direction of the electric wire 23 becomes a longitudinal direction.

For example, the powder sintering lamination shaping method can be used for stereoscopic shaping. Unlike the powder sticking lamination shaping method in which a binder is applied to material powder to attach and laminate the material powder, the powder sintering lamination shaping method is characterized in that metal/resin powder is melted, sintered and laminated sequentially using a laser heat source to form a desired shape. The powder sintering lamination shaping method can form various forming materials ranging from resin materials to metals and ceramics, whereas almost all of the other lamination shaping methods including the optical shaping method have limitations on forming materials.

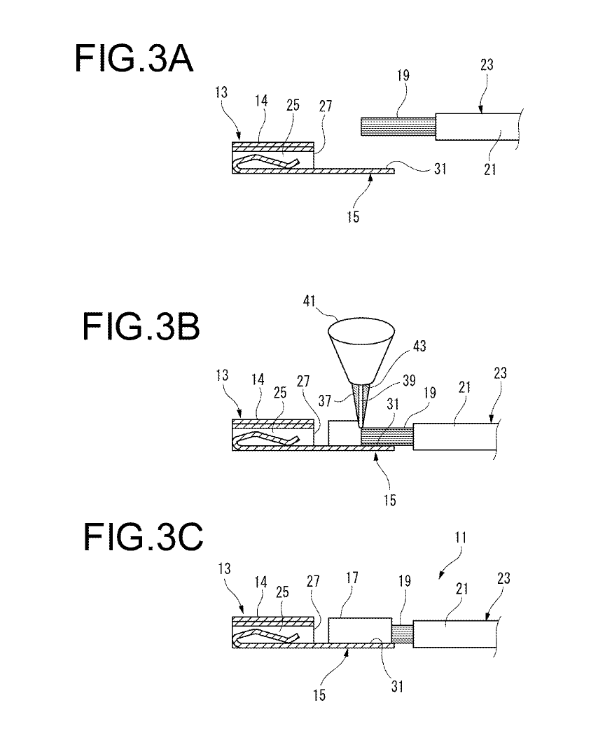

In the powder sintering lamination shaping method, metal powder 37 is laminated while being melted using a laser heat source in a forming chamber as illustrated in FIGS. 3A to 3C. The forming chamber is provided with an IR heater for heating. When the material melted by laser irradiation 39 is abruptly cooled immediately after fused with an existing layer, a large internal stress is generated between the layers. To solve this problem, the temperature of the forming environment is raised close to the melting point of the forming material using the IR heater, so that abrupt cooling is suppressed and occurrence of the internal stress can be prevented. Furthermore, a nitrogen atmosphere is provided in the forming chamber to prevent combustion and oxidation.

As a laser to be mounted on a head 41, a CO₂ laser or a YAG laser is used. In addition, the head 41 is provided with a material supply nozzle 43. The operation of the head 41 is controlled on the basis of 3D CAD data. Like the spindles of a machine tool, the head 41 is subjected to simultaneous multi-spindle control. Furthermore, in the powder sintering lamination shaping method, control is performed while the irradiation amount of laser light, the supply amount of material, etc. are monitored at all times, whereby metal layers in precise pitches regardless of the shape of the face to be shaped can be formed.

In the powder sintering lamination shaping method, hybrid shaping using powdery metal for general industry use is also made possible. In other words, the metallic connection portion 17 can be additionally shaped on the bottom plate 31 of the terminal 13. The entire terminal 13 can also be formed by stereoscopic shaping as a matter of course. At the time, the base member (terminal 13) is not limited to have a flat face. The surface of the base member (bottom plate 31) to be shaped additionally may include a three-dimensional free curved face. In other words, the above-mentioned rising pieces 33 and the like may have been already formed.

In the powder sintering lamination shaping method, metals, such as titanium, stainless steel, nickel alloy, Inconel (registered trademark), aluminum (Al), copper (Cu) and tin (Sn), can be used. In addition, various materials, such as engineering plastics, ceramics and sand, can be selectively used according to the application.

Furthermore, as stereoscopic shaping for producing metallic shaped articles using metal particles, for example, a three-dimensional metal object producing method (for example, refer to JP-A-2005-120475) can be used; the method has the step of depositing a particle mixture containing a plurality of kinds of metal particles or metal alloy particles and a peroxide in limited regions and the step of selectively ejecting a binder to the predetermined areas of the above-mentioned particle mixture using the inkjet system to form unprocessed portions.

In the first embodiment, as illustrated in FIG. 2, the metallic connection portion 17 formed by stereoscopic shaping is preferably formed so that the cross-sectional shape thereof being orthogonal to the extension direction of the conductor 19 dose not protrude from the external shape of the box section 25 of the electric contact portion 14. With this configuration, for example, when the terminal is inserted into the housing, the metallic connection portion 17 formed at the terminal 13 is hardly hooked.

Moreover, in the terminal-equipped wiring member 11, the conductor 19 is preferably embedded in the metallic connection portion 17 while making contact with the bottom plate 31. It is important that the conductor 19 makes contact with the bottom plate 31 in the forming process of the metallic connection portion 17, instead of making contact with the bottom plate 31 after the forming of the metallic connection portion 17. As a result, the conductor 19 is in a state of being embedded in the metallic connection portion 17 while making contact with the bottom plate 31. Making the conductor 19 in contact with the bottom plate 31 in the process of forming the metallic connection portion 17 has an effect of suppressing the displacement of the conductor 19.

Next, the action of the terminal-equipped wiring member 11 according to the first embodiment will be described.

In the terminal-equipped wiring member 11 according to the first embodiment, the metallic connection portion 17 is formed by stereoscopic shaping at the conductor connection portion 15 of the terminal 13. While the conductor 19 is placed on the conductor connection portion 15, a forming material is gradually laminated on the conductor connection portion 15 by stereoscopic shaping, whereby the metallic connection portion 17 is formed. Hence, the conductor 19 placed on the conductor connection portion 15 is buried (embedded) into the metallic connection portion 17 having been formed by stereoscopic shaping.

The metallic connection portion 17 can be made of the same metal material as that of the conductor connection portion 15 of the terminal 13. Furthermore, the metallic connection portion 17 may be made of the same metal material as that of the conductor 19. The metallic connection portion 17 formed on the conductor connection portion 15 is formed such that the boundary portion between the metallic connection portion 17 and the conductor connection portion 15 is melted and integrated with the conductor connection portion 15. Since the conductor 19 is composed of the plurality of strands 47 as illustrated in FIG. 2, the metallic connection portion 17 is brought into a melted state when it is formed and enters gaps among the strands, and then hardens.

Hence, the contact area between the terminal 13 and the conductor 19 in the metallic connection portion 17 can be made larger than that in the conventional terminal connection structure (mechanical fastening), such as crimping, pressure contact and piercing. In addition, the damage to the conductor 19 due to plastic deformation is smaller than the damage due to mechanical fastening. As a result, the tensile strength between the terminal 13 and the electric wire 23 can be raised to as high as the tensile strength of the conductor 19.

Besides, the tensile strength between the terminal 13 and the electric wire 23 can be raised further by continuously providing a coating crimping section formed of a pair of crimping pieces behind the bottom plate 31 and by crimping the electric wire 23 from around the outer circumference of the cover 21.

What is more, since the conductor 19 is embedded into the metallic connection portion 17 that is integrally formed with the terminal 13, the connection resistance thereof is low and stable. As a result, the electric performance obtained by the forming can be made higher than that obtained by the mechanical fastening.

Additionally, the kinds of components can be decreased and the kinds of processing facilities can also be decreased by sharing the terminal 13 and the stereoscopic shaping machine. As a result, component/facility management cost and processing cost can be reduced, and manufacturing cost can be reduced.

Next, a terminal-equipped wiring member 11A according to a second embodiment of the present invention will be described.

The terminal-equipped wiring member 11A according to the second embodiment is almost similar to the terminal-equipped wiring member 11 according to the first embodiment, except that the metallic connection portion 17 in the terminal-equipped wiring member 11 according to the first embodiment is replaced with a metallic connection portion 17A. Hence, the same members are designated by the same reference numbers and their detailed descriptions are omitted.

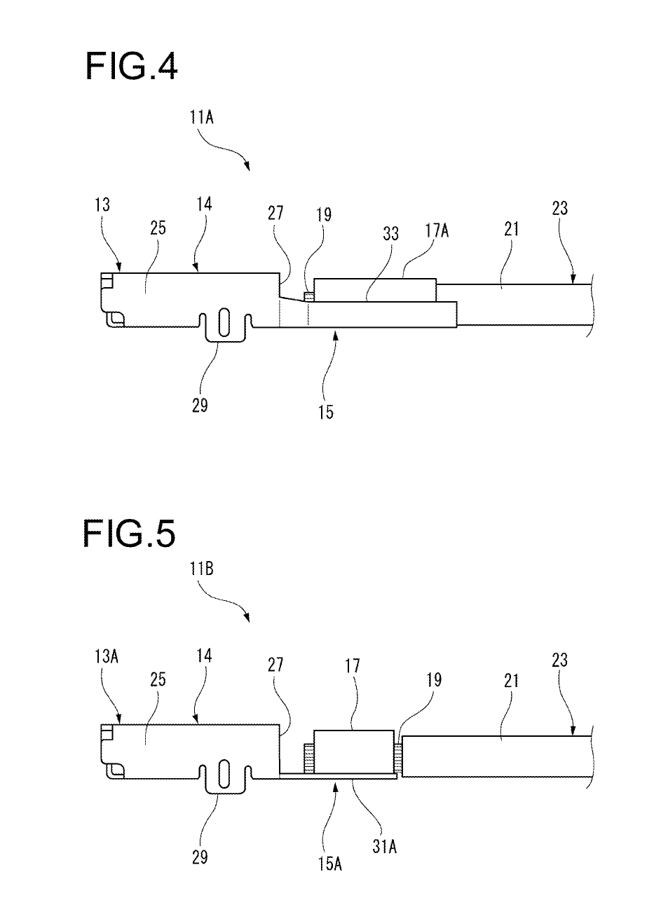

The terminal-equipped wiring member 11A according to the second embodiment is configured so that the metallic connection portion 17A continuously covers the conductor 19 and the cover 21 as illustrated in FIG. 4.

The metallic connection portion 17A of the terminal-equipped wiring member 11A completely covers the conductor 19 exposed at the terminal end of the electric wire 23, thereby achieving water stopping among the wire strands of the conductor 19.

Next, a terminal-equipped wiring member 11B according to a third embodiment of the present invention will be described.

The terminal-equipped wiring member 11B according to the third embodiment is almost similar to the terminal-equipped wiring member 11 according to the first embodiment, except that the terminal 13 in the terminal-equipped wiring member 11 according to the first embodiment is replaced with a terminal 13A. Hence, the same members are designated by the same reference numbers and their detailed descriptions are omitted.

The conductor connection portion 15A of the terminal 13A of the terminal-equipped wiring member 11B according to the third embodiment is formed as a bottom plate 31A having a rectangular plate shape and extending from the box section 25 of the electric contact portion 14 as illustrated in FIG. 5.

The conductor connection portion 15A of the terminal 13A of the terminal-equipped wiring member 11B is formed into a common shape, that is, a simple rectangular plate shape. By virtue of this configuration, the processing of the terminal 13A can be made simple and the manufacturing cost of the terminal can be reduced.

In addition, since the conductor connection portion 15A has a flat face, the laser irradiation 39 can be facilitated in the case that the powder sintering lamination shaping method is used for stereoscopic shaping.

Consequently, the terminal-equipped wiring members 11, 11A and 11B according to the respective embodiments make it possible to decrease the kinds of different exclusive terminals and the kinds of different processing facilities, thereby reducing the manufacturing cost.

The features of the above-mentioned embodiments of the terminal-equipped wiring member according to the present invention will be briefly summarized and listed below.

[1] There is provided a terminal-equipped wiring member 11 including:

a wiring member (electric wire) 23 having a conductor 19 covered with an insulating cover 21;

a terminal 13 having an electric contact portion 14 configured to be electrically connected to a mating terminal and a conductor connection portion 15 connected to the conductor 19; and

a metallic connection portion 17 formed at the conductor connection portion 15 by stereoscopic shaping (3D molding) and configured to embed the conductor 19 therein so that the conductor connection portion 15 and the conductor 19 are integrally fixed to each other.

[2] The terminal-equipped wiring member 11B described in the above item [1], wherein the conductor connection portion 15A is formed as a bottom plate 31A having a rectangular plate shape and extending from the electric contact portion 14.

[3] The terminal-equipped wiring member 11A described in the above item [1] or [2], wherein the metallic connection portion 17A continuously covers both the conductor 19 and the cover 21.

Meanwhile, the present invention is not limited to the above-mentioned embodiments, but can be modified and improved as necessary. In addition, the materials, shapes, dimensions, numbers, arrangement positions, etc. of the respective components in the above-mentioned embodiments may be arbitrary and not limited, provided that the present invention can be achieved.

The present application is based on Japanese Patent Application No. 2014-037146 filed on Feb. 27, 2014, the contents of which are incorporated herein by reference.

What is claimed is:

1. A terminal-equipped wiring member comprising:
a wiring member having a conductor covered with an insulating cover;
a terminal having an electric contact portion configured to be electrically connected to a mating terminal and a conductor connection portion connected to the conductor; and
a metallic connection portion formed at the conductor connection portion by stereoscopic shaping and configured to embed the conductor therein so that the conductor connection portion and the conductor are integrally fixed to each other.

2. The terminal-equipped wiring member according to claim 1, wherein the conductor connection portion is formed as a bottom plate having a rectangular plate shape and extending from the electric contact portion.

3. The terminal-equipped wiring member according to claim 1, wherein the metallic connection portion continuously covers both the conductor and the insulating cover.
